(19) United States
(12) Patent Application Publication
(10) Pub. No.: US 2026/0248203 A1
(43) Pub. Date: Aug. 27, 2026

(54) Aerosol Generating Device with an Orientation Sensor

(71) Applicant: JT International SA, Geneva (CH)

(72) Inventors: Layth Sliman Bouchuiguir, Bellevue (CH); Jeroen Dammers, Zwolle (NL)

(73) Assignee: JT International SA, Geneva (CH)

(21) Appl. No.: 18/873,432

(22) PCT Filed: Jul. 13, 2023
(86) PCT No.: PCT/EP2023/069544

§ 371 Date: Dec. 10, 2024

(30) Foreign Application Priority Data
Jul. 19, 2022 (EP) 22185857.4

(51) Int. Cl. A24F 40/57; A24F 40/51; A24F 40/60

(52) U.S. Cl. CPC A24F 40/57; A24F 40/51; A24F 40/60

(57) ABSTRACT

An aerosol generating device is disclosed. The aerosol generating device comprises an orientation sensor configured to detect the orientation of the device; a sensor configured to detect tapping or shaking events at the device; and a controller configured to enable the sensor to detect tapping or shaking upon determining that the orientation of the device detected by the orientation sensor is within a predefined orientation range. The controller is also configured to disable the sensor upon determining that the orientation of the device detected by the orientation sensor is not within a predefined orientation range. The controller is further configured to operate a component of the device upon detection of tapping or shaking when the sensor is enabled.

### FIELD OF THE INVENTION

The present invention relates to an aerosol generating device. In particular, the invention relates to an aerosol generating device with an orientation sensor for improved safety.

### BACKGROUND

There is a demand for aerosol generating devices such as electronic cigarettes with improved safety and usability. It is an object of the present invention to provide an aerosol generating device that can address some of these requirements.

### SUMMARY OF INVENTION

According to an aspect of the invention there is provided an aerosol generating device, comprising: an orientation sensor configured to detect the orientation of the device; a sensor configured to detect tapping or shaking events at the device; and a controller configured to enable the sensor to detect tapping or shaking upon determining that the orientation of the device detected by the orientation sensor is within a predefined orientation range, and to disable the sensor upon determining that the orientation of the device detected by the orientation sensor is not within a predefined orientation range, wherein the controller is further configured to operate a component of the device upon detection of tapping or shaking when the sensor is enabled.

In this way, the safety of the device is improved because the likelihood of the sensor of the device being activated unintentionally is reduced. The sensor can only detect tapping or shaking of the device when the device is in a certain orientation. Therefore, the likelihood of the device being operated unintentionally is reduced when the device is not in an orientation that is associated with normal use, such as when the device is in a user's bag or pocket.

Preferably, the controller is configured to detect shaking that involves a movement of the device in the horizontal, vertical, or azimuthal directions.

Preferably, the controller is further configured to operate a component of the device upon determining a direction of movement when the device is being shaken.

The controller of the device can preferably recognise shaking movements in multiple directions and the controller can therefore associate these with different instructions that the user may wish to give to the device. The controller can determine in which direction the device is being tapped/shaken from data from the sensor. In this way, the user experience can be improved. For example, shaking in a vertical direction can be used to instruct the controller to turn on the heater of the device, shaking in a horizontal direction may instruct the controller turn off the heater of the device and shaking in an azimuthal direction may instruct the controller to present information on the battery status of the device.

Preferably, the controller is configured to operate a heating function of the device upon detection of tapping or shaking when the sensor is enabled.

Preferably, the orientation sensor comprises a gyroscope. In this way, the orientation of the device may be detected precisely. The orientation sensor may be a PCB board mounted device.

Preferably, the sensor comprises an accelerometer. In this way, the motion of the device may be detected precisely. More specifically, tapping or shaking of the device may be detected more precisely. The sensor may be a PCB board mounted device.

Preferably, the device comprises an outer body. Preferably, the sensor is connected to the outer body. In this way, the sensor can accurately detect tapping or shaking as the sensor is connected to a rigid outer body.

Preferably, the sensor is configured to detect the number of times the outer body of the device has been tapped. Preferably, the sensor is configured to detect the location on the outer body that has been tapped. The sensor can, in this way, detect intentional tapping and shaking inputs from a user, as opposed to those which may be accidental. Preferably, the predefined orientation range comprises orientations where the longitudinal axis of the device is confined within a cone defined around a vertical axis. Preferably, the predefined orientation range is bounded by the surface of the cone that is defined around the vertical axis, and wherein the sensor is enabled sensor to detect tapping or shaking upon determining that the orientation of the device detected by the orientation sensor is within the bounding surface of the cone.

In this way, the sensor can be enabled when the device is in an orientation that is most likely to correspond with an orientation of intended use. It is understood that users can hold aerosol generation devices in a number of different ways and can hold the devices differently in different contexts. However, it has been found that the most of intended uses of the device correspond to instances where the device is held such that its longitudinal axis is within a cone that is defined around the vertical axis.

According to an aspect of the present invention there is provided a method for using an aerosol generating device, comprising: detecting the orientation of the device using an orientation sensor; enabling a sensor to detect tapping or shaking events using a controller upon determining that the orientation of the device detected by the orientation sensor is within a predefined orientation range, and disabling the sensor using the controller upon determining that the orientation of the device detected by the orientation sensor is not within a predefined orientation range; and operating a component of the device using the controller upon the detection of tapping or shaking events when the sensor is enabled.

According to another aspect of the present invention there is provided a computer program product comprising executable instructions which, when executed by a computer, cause the computer to carry out the method steps defined above.

According to another aspect of the invention there is provided an aerosol generating device, comprising: a motion sensor configured to detect the motion of the device; a sensor configured to detect user inputs; and a controller configured to operate a component of the device when motion of the device is detected by the motion sensor and a user input is subsequently detected by the sensor, wherein the motion of the device detected by the motion sensor corresponds to a predetermined motion.

In this way, the safety of the device is improved because the likelihood of a component of the device being activated unintentionally is reduced because the device must be moved in a motion that corresponds to a predetermined motion and a user input must be subsequently detected in order for the component to be operated. The component of the device cannot be operated when the device is not being moved in a manner that is associated with normal use or when the device is substantially stationary, such as when the device is in a user's bag or pocket.

Preferably, the controller is configured to enable the sensor to detect user inputs upon determining that the motion of the device corresponds to a predetermined motion, and to disable the sensor to detect user inputs upon determining that the motion of the device does not correspond to the predetermined motion, wherein the controller is further configured to operate a component of the device upon detection of a user input when the sensor is enabled.

The sensor can be enabled when the device has been moved in a manner that is characteristic of a user picking the device up. It is understood that users can hold aerosol generation devices in a number of different ways and can hold the devices differently in different contexts. Some users may wish to operate the device whilst lying down. However, irrespective of the preferred kind of use it is common for a device first to be picked up from a stationary position. This action corresponds to a predetermined motion having expected acceleration values in a Cartesian reference frame and expected rotations in yaw, pitch, and roll.

Preferably, the controller is configured to prevent operation of a component of the device if the user input is not detected by the sensor within a predefined time period of the predetermined motion. Preferably, following detection of the predetermined motion, which may correspond with enablement of the sensor, the controller is further configured to disable the sensor after a predefined time period. Preferably, the predefined time period is 3 seconds. In this way, the usability and safety of the device is further improved. During transit the device may be accidentally moved in a manner that could by coincidence be indicative of a user picking up the device. The device preferably cannot be activated unless an input has been received in a certain amount of time. Also, during normal use the user input is typically provided during a predictable time window after the end of the predetermined motion.

Preferably, the motion sensor comprises an accelerometer. In this way, the translational movement of the device may be detected precisely. The accelerometer may be a PCB board mounted device.

Preferably, the motion sensor comprises a gyroscope. In this way, the orientation of the device may be detected precisely. The gyroscope may be a PCB board mounted device.

In some embodiments the sensor and the motion sensor may be one and the same. For example, the sensor and the motion sensor may comprise an accelerometer. In another embodiment the sensor and the motion sensor may be separate and discrete components. For example, the sensor may be a button and the motion sensor could comprise an accelerometer. In some embodiments the sensor may comprise one or more of a button and an accelerometer.

The motion sensor may comprise one or more of an accelerometer or a gyroscope and the motion data can comprise acceleration values in a Cartesian reference frame and rotations in yaw, pitch and roll.

Preferably, the motion sensor is configured to send motion data corresponding to the detected motion of the device to the controller, wherein the controller is configured to store the motion data in a data storage medium.

Preferably, the controller is configured to compare the motion data with data stored in the data storage medium corresponding to the predetermined motion.

In this way, the controller can accurately determine whether the detected motion of the device matches the predetermined motion. The data corresponding to the predetermined motion can also comprise acceleration values in a Cartesian reference frame and rotations in yaw, pitch, and roll. The controller may tolerate a certain quantity of deviance between the motion data and the data corresponding to the predetermined motion as the user may not pick up the device in the same manner each time they wish to use the device.

Preferably, the predetermined motion is indicative of a user picking up the device. In this way, the sensor is less likely to be activated unintentionally. Motions indicative of a user picking up the device may comprise those where the longitudinal axis of the device is rotated from a substantially horizontal orientation to a substantially vertical orientation. However, other motions may be possible for different pick-up actions and scenarios.

Preferably, the motion data comprises a time stamp indicating the time at which the motion of the device was detected by the motion sensor.

In this way, the controller is able to determine when the device was most recently picked up. The controller can therefore determine whether a user input has been received within the predefined time period.

Preferably, the controller is configured to delete the motion data from the data storage medium following a predefined duration from the time stamp. Preferably, the predefined duration is 30 minutes, one hour, or one day.

Preferably, the controller is further configured to enable the sensor to detect user inputs upon determining that the orientation of the device detected by the motion sensor is within a predefined orientation range. Preferably, the controller is further configured to disable the sensor upon determining that the orientation of the device detected by the motion sensor is not within a predefined orientation range. In this way, the safety of the device is further improved because the likelihood of sensor of the device being activated unintentionally is further reduced. This double requirement means that the sensor can accept user inputs only when a predetermined motion is detected and, following the predetermined motion, the device is in a predefined orientation range.

Preferably, the predefined orientation range comprises orientations where the longitudinal axis of the device is confined within a cone defined around a vertical axis. In this way, the sensor can be enabled when the device is in an orientation that is most likely to correspond with an orientation of intended use, after it has been picked up. It is understood that users can hold aerosol generation devices in a number of different ways and can hold the devices differently in different contexts. However, it has been found that the most of intended uses of the device correspond to instances where the device is held such that its longitudinal axis is within a cone that is defined around the vertical axis.

According to another aspect of the invention there is provided a method for operating an aerosol generating device, comprising: detecting the motion of the device using a motion sensor; and operating a component of the device when motion of the device is detected by the motion sensor and a user input is subsequently detected by a sensor, wherein the motion of the device detected by the motion sensor corresponds to a predetermined motion.

According to another aspect of the present invention there is provided a computer program product comprising executable instructions which, when executed by a computer, cause the computer to carry out the method steps defined above.

Features of one aspect of the invention can be combined with those of any other aspect of the invention. Further, apparatus features can be provided as corresponding method features, and vice-versa.

### BRIEF DESCRIPTION OF DRAWINGS

Embodiments of the invention are now described, by way of example, with reference to the drawings, in which:

FIG. 1 is a schematic diagram of a device in an embodiment of the invention;

FIG. 2 is a flowchart showing a control sequence in an embodiment of the invention;

FIG. 3 is a schematic diagram of a predefined orientation region in an embodiment of the invention;

FIG. 4 is a flowchart showing a control sequence in an embodiment of the invention;

FIG. 5 is a schematic diagram of a device, in an embodiment of the invention, wherein the orientation of the device is depicted as changing from a first starting orientation to a first finishing orientation;

FIG. 6 is a schematic diagram of a device, in an embodiment of the invention, wherein the orientation of the device is depicted as changing from a second starting orientation to a second finishing orientation;

FIG. 7 is a schematic diagram of a device, in an embodiment of the invention, wherein the orientation of the device is depicted as changing from a third starting orientation to a third finishing orientation; and

FIG. 8 is a flowchart showing a control sequence in another embodiment of the invention.

### DETAILED DESCRIPTION

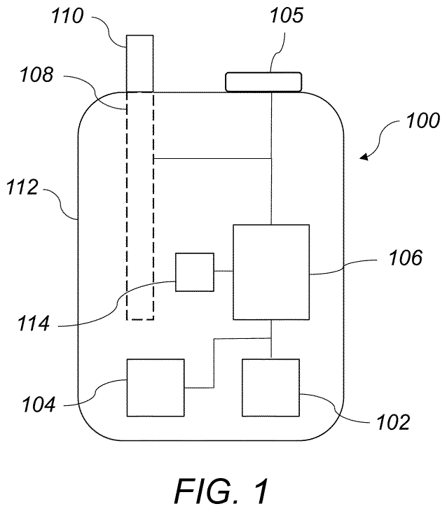

FIG. 1 is a schematic diagram of an aerosol generating device 100 in an embodiment of the invention. The aerosol generating device 100 comprises an orientation sensor 102 configured to detect the orientation of the aerosol generating device 100, a sensor 104 configured to detect tapping or shaking events at the aerosol generating device 100, a button 105 configured to detect user inputs, a controller 106, a heater 108 configured to heat a consumable 110, an outer body 112 and a data storage medium 114.

The orientation sensor 102 is configured to detect the orientation of the aerosol generating device 100. More specifically, the orientation sensor 102 is configured to measure the angle subtended by the longitudinal axis of the device 100 relative to a vertical axis, based on local gravity.

The orientation sensor 102 can comprise one or more sensors. Examples of appropriate sensors include, but are not limited to, a gyroscope, an accelerometer, a magnetometer, or any combination thereof. The orientation sensor 102 is logically connected to the controller 106. The orientation sensor 102 is configured to provide a continuous stream of data to the controller 106 indicating time-series orientation data. The frequency with which orientation data are provided to the controller 106 by the orientation sensor 102 is a design feature.

The sensor 104 is configured to detect motion of the device, which includes tapping or shaking events by a user at the device 100. The sensor 104 can comprise one or more sensors, as would be understood by a person skilled in the art. Examples of appropriate sensors include, but are not limited to, an accelerometer, the button 105 or any combination thereof.

The sensor 104 is physically connected to the outer body 112 of the device 100. More specifically, the sensor 104 is rigidly connected to the outer body 112 to ensure that the data signals outputted by the sensor 104 corresponding to detected tapping or shaking events are not unnecessarily dampened.

The sensor 104 is able to detect motion of the device 100 that involves movement of the device in the horizontal, vertical, or azimuthal directions and tapping events on the outer body 112 of the device 100. The sensor 104 is configured to detect the number of times the outer body 112 of the device has been tapped and, optionally, the location on the outer body 112 that has been tapped. The sensor 104 is logically connected to the controller 106. The sensor 104 provides data to the controller 106 that is characteristic of different types of tapping or shaking events when such events are detected by the sensor 104, the controller 106 is therefore able to detect different types of tapping or shaking events.

In various embodiments of the invention, the sensor 104 is able to detect translational movement of the device and tapping and shaking events at the device. Data from the sensor 104 and orientation sensor 102 provide the controller 106 with information regarding the overall motion of the device comprising translational and orientational movements of the device, as well as information regarding user inputs when the sensor 104 is enabled to detect user inputs.

The controller 106 is configured to enable the sensor 104 to detect tapping or shaking upon determining that the orientation of the device 100 detected by the orientation sensor 102 is within a predefined orientation range, and to disable the sensor 104 upon determining that the orientation of the device 100 detected by the orientation sensor 102 is not within a predefined orientation range. The controller 106 is further configured to operate a component of the device, such as the heater 108, upon detection of tapping or shaking when the sensor 104 is enabled.

The controller 106 is configured to receive data from the orientation sensor 102 and the sensor 104. The controller 106 is configured to operate components of the device 100, such as the heater 108, based on user inputs, including the direction in which the device is being shaken. The controller 106 is further configured to operate components of the device, such as the heater 108, corresponding to the location and/or number of times the outer body of the device 112 is tapped by a user, based on data received from the sensor 104 when the sensor 104 is enabled. For example, if the controller 106 determines from data from the sensor 104 that the device has been shaken in the vertical direction, the controller will turn the heater 108 on.

The heater 108 is configured to heat a consumable 110 that is received through an opening (not shown), wherein the consumable 110 comprises an aerosol generating substance. The aerosol generating substance may comprise a tobacco substrate which may be solid or semi-solid that can be heated without burning. In alternative scenarios the consumable 110 may comprise other kinds of substrate such as a vaporisable liquid substrate held in a reservoir.

In the case where the aerosol generating device 100 is a heat-not-burn device, the heater 108 may be further configured to heat a solid consumable 110 received through the opening.

The solid consumable 110 may comprise shredded tobacco. Solid consumables known in the art may comprise a mouthpiece portion or simply an end from which the user may inhale an aerosol.

The heater 108 may comprise any of an electrically resistive heater, a convective heater, an inductive heater, a laser heater, or any heating device known in the art. The skilled person would understand that the heater 108 may comprise a plurality of heating stages such as a preheating stage and a main heating stage.

The data storage medium 114 is configured to store data regarding the predefined orientation range. The data storage medium 114 is further configured to store data regarding pre-programmed tapping or shaking events and instructions as to which components of the device 100 to operate based on whether such tapping or shaking events are detected by the sensor 104. The controller 106 is logically connected to the data storage medium 114 and is configured to access data from the data storage medium 114.

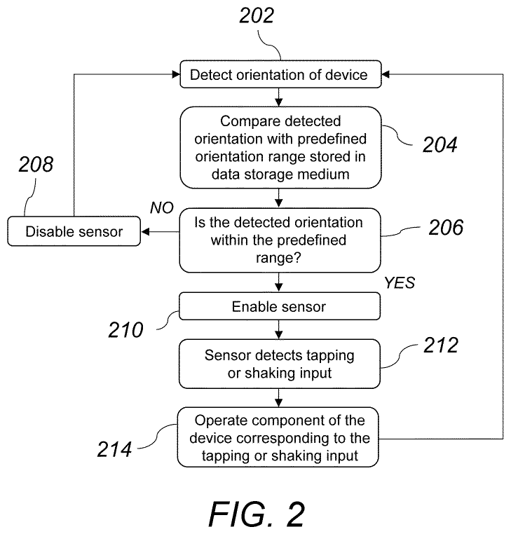

FIG. 2 is a flowchart showing a control sequence in an embodiment of the invention. At step 202, the orientation sensor 102 detects the orientation of the aerosol generating device 100. The orientation sensor 102 is configured to provide a continuous stream of data to the controller 106 indicating time-series orientation data. Data regarding the current orientation of the aerosol generating device 100 is fed to the controller 106 from the orientation sensor 102. The orientation data may be presented in a variety of formats including, for example, polar coordinates for the longitudinal axis of the device with respect to a vertical axis, or simply an angle subtended by the longitudinal axis of the device and the vertical axis.

At step 204, the controller 106 receives data regarding the current orientation of the aerosol generating device 100 from the orientation sensor 102. The controller 106 is configured to read data stored in the data storage medium 114. The data storage medium 114 is configured to store data comprising a preferred orientation range. Data stored in the data storage medium 114 is indicative of the boundary of the predefined orientation range.

At step 206, the controller 106 determines whether or not the detected orientation of the aerosol generating device 100 is within the predefined orientation range based on the comparison between the orientation data received from the orientation sensor 102 and the data comprising the predefined orientation range stored in the data storage medium 114.

If the controller 106 determines that the detected orientation of the aerosol generating device 100 is not within the predefined orientation range the controller 106 is configured to disable the sensor 104 at step 208. Once the sensor 104 is disabled, the user cannot provide tapping or shaking inputs to the device that are indicative of instructions to operate components of the aerosol generating device 100, such as the heater 108.

If the controller 106 determines that the detected orientation of the aerosol generating device 100 is within the predefined orientation range the controller 106 is configured to enable the sensor 104 at step 210. Once the sensor 104 is enabled, the user can provide tapping or shaking inputs to the device indicative of instructions to operate components of the device, such as the heater 108.

At step 212, the sensor 104 detects a tapping or shaking input from the user. Data is fed to the controller 106 from the sensor 104. The tapping or shaking data may be presented in the form a waveform plotting the proper acceleration of the device measured by the sensor 104 over time.

At step 214, the controller 106 receives the tapping or shaking data from the sensor 104. The controller 106 is configured to compare the tapping or shaking data with data stored in the data storage medium 114. The data stored in the data storage medium 114 represents pre-programmed tapping or shaking patterns, such as shaking in the vertical direction or tapping the device twice. If the tapping or shaking data matches the pre-programmed tapping or shaking patterns the controller 106 will operate the component of the device that corresponds to the tapping or shaking data.

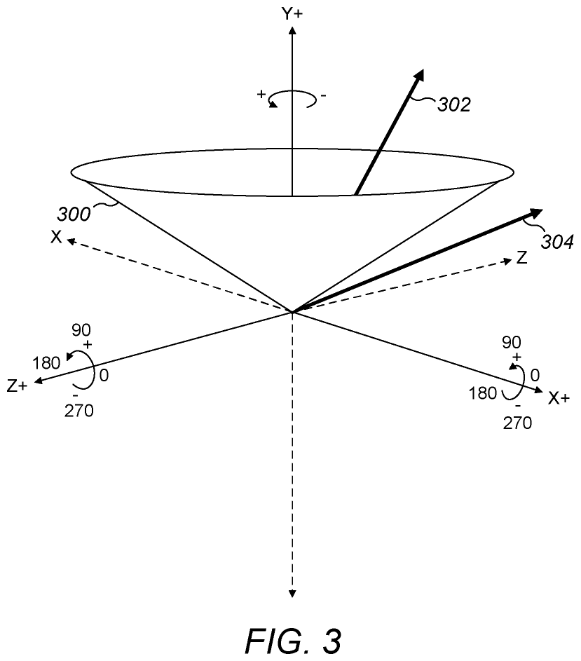

FIG. 3 is a schematic diagram of a predefined orientation range in an embodiment of the invention. In this example, the preferred operational orientation range is bounded by the surface of a cone 300 that is arranged about a vertical axis (in this case, the Y-axis). FIG. 3 shows a first example orientation 302 which is within the bounding surface of the cone 300 and is therefore within the predefined orientation range. FIG. 3 also shows a second example orientation 304 which lies outside the bounding surface of the cone 300 and is therefore outside the predefined orientation range.

Data stored in the data storage medium 114 is indicative of the boundary of the predefined orientation range 302. This can comprise storing an angle in a polar or cylindrical coordinate system.

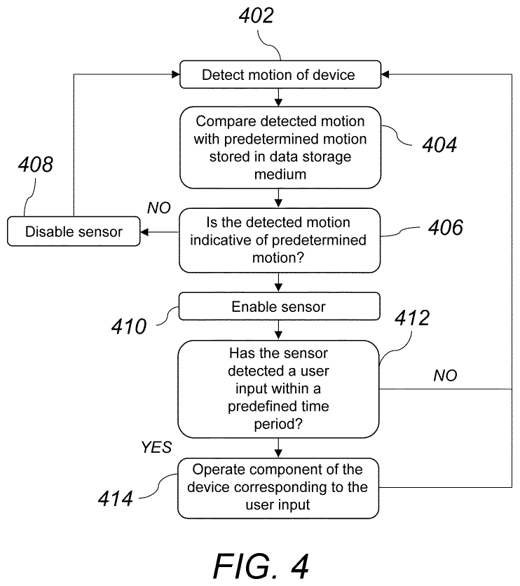

FIG. 4 is a flowchart showing a control sequence in another embodiment of the invention. At step 402, the sensor 104 detects a motion of the aerosol generating device 100. The sensor 104 is configured to provide a continuous stream of data to the controller 106 indicating time-series motion data, which may comprise accelerometer data in a Cartesian reference frame. The motion of the aerosol generating device 100 may also include changes in its orientation from the orientation sensor 102, including yaw, pitch and roll angular rotations. Data regarding the current motion of the aerosol generating device 100 is fed to the controller 106 from the sensor 104.

At step 404, the controller 106 receives data regarding the current motion of the aerosol generating device 100 from the sensor 104 and optionally the orientation sensor 102 as well. The controller 106 is configured to read data stored in the data storage medium 114. The data storage medium 114 is configured to store data comprising a predetermined motion. Data stored in the data storage medium 114 is indicative of the translational and orientational movements of the device in the predetermined motion.

At step 406, the controller 106 is configured to determine whether or not the detected motion of the aerosol generating device 100 substantially matches the predetermined motion based on the comparison between the motion data received from the sensor 104 and the data comprising the predetermined motion stored in the data storage medium 114. The predetermined motion can include minimum and maximum values for expected speed of movement, range of movement and angular rotations that would be expected with the typical action of a user picking up the device 100. The predetermined motion can therefore provide a bounded range of motions, all of which would be expected for a typical pick-up action.

If the controller 106 determines that the detected motion of the aerosol generating device 100 is not indicative of predetermined motion the controller 106 is configured to disable the sensor 104 at step 408. Once the sensor 104 is disabled, the user cannot provide inputs to the device that are indicative of instructions to operate components of the aerosol generating device 100, such as the heater 108 If the controller 106 determines that the detected motion of the aerosol generating device 100 is indicative of predetermined motion the controller is configured to enable the sensor 104 at step 410. Once the sensor 104 is enabled, the user can provide inputs indicative of instructions to operate components of the aerosol generating device 100, such as the heater 108.

At step 412, the controller 106 determines whether or not a user input has been detected by the sensor 104 within a predefined time period. The controller 106 may comprise a timing function that measures the amount of time that has elapsed from when the sensor 104 was enabled. Alternatively, the controller 106 may comprise a count-down function.

If the controller 106 detects that a user input has been received by the sensor 104 within the predefined time period, the controller 106 will operate the component of the device corresponding to the instruction provided by the user in the user input at step 414. For example, a user input of pressing the button 105 of the device may instruct the controller to activate the heater 108. This can prevent accidental operation of the device 100.

In an embodiment of the invention the control sequences portrayed in the embodiments of FIGS. 2 and 4 are combined. Following the controller 106 determining that the detected motion of the aerosol generating device 100 is indicative of predetermined motion at step 406 in the embodiment of FIG. 4, the orientation sensor 102 detects the orientation of the aerosol generating device 100, at step 202 in the embodiment of FIG. 2.

Steps 204 and 206 are subsequently executed and if the controller 106 determines that the detected orientation of the aerosol generating device 100 is not within the predefined orientation range the controller 106 is configured to disable the sensor 104. Alternatively, If the controller 106 determines that the detected orientation of the aerosol generating device 100 is within the predefined orientation range the controller 106 is configured to enable the sensor 104. Following enablement of the sensor 104 step 412, and if step 412 is satisfied, step 414 in the embodiment of FIG. 4 is executed.

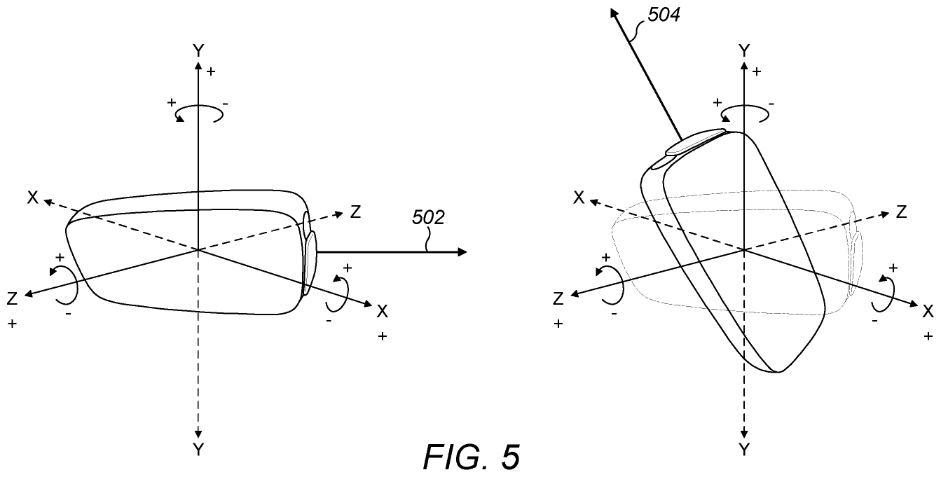

The predetermined motion is indicative of a user picking up the device. For example, the predetermined motion may be that the longitudinal axis of the device has rotated 90-180 degrees (±20 degrees) from the horizontal plane (the Z or X axis, as shown in FIGS. 5 to 7). A wide variety of motions may fall within the bounds of a predetermined motion to cover the different methods that users can employ for a pick-up action.

FIGS. 5, 6, and 7 are schematic diagrams showing possible motions of the device to illustrate steps 402, 404 and 406 in FIG. 4.

FIG. 5 is a schematic diagram of a device in an embodiment of the invention, wherein the orientation of the device is depicted as changing from a first starting orientation 502 to a first finishing orientation 504.

The longitudinal axis of the device resides in the horizontal plane (the X-Z plane) in the first starting orientation 502. At step 402 in the embodiment of the invention according to FIG. 4, the sensor 104 detects that the longitudinal axis of the device rotates through 120 degrees in the negative X-direction to reach the first finishing orientation 504. At step 404, the controller receives data from the sensor 104 and the orientation sensor 102 throughout the movement of the device between the first starting orientation 502 and the first finishing orientation 504. At step 406, the controller compares the received data of the motion of the device between the orientations 502 and 504 with data of predetermined motions stored in the data storage medium 114. In this scenario, the sensor 104 of the device will be enabled to detect user inputs at step 410 as the longitudinal axis of the device has been rotated through an angle that satisfies the conditions of the predetermined motion given in the aforementioned example (rotated 90-180 degrees (±20 degrees) from the horizontal plane).

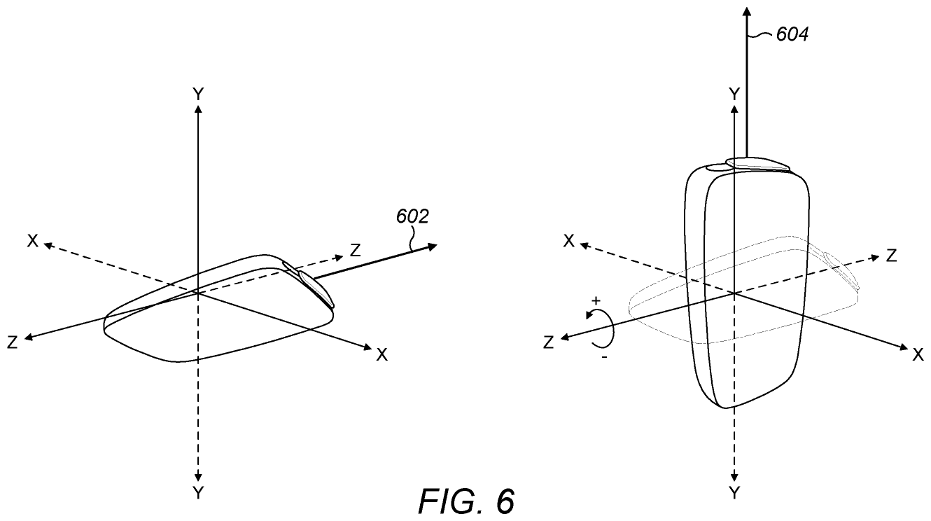

FIG. 6 is a schematic diagram of a device in an embodiment of the invention, wherein the orientation of the device is depicted as changing from a second starting orientation 602 to a second finishing orientation 604.

The longitudinal axis of the device is parallel with the Z-axis in the horizontal plane in the second starting orientation 602. At step 402 in the embodiment of the invention according to FIG. 4, the sensor 104 detects that the longitudinal axis of the device rotates through 90 degrees in the positive Z-direction to reach the first finishing orientation 604. At step 404, the controller receives data from the sensor 104 and the orientation sensor 102 throughout the movement of the device between the second starting orientation 602 and the second finishing orientation 604. At step 406, the controller compares the received data of the motion of the device between the orientations 602 and 604 with data of predetermined motions stored in the data storage medium 114. The sensor 104 of the device will be enabled to detect user inputs at step 410 as the motion of the device satisfies the conditions of the predetermined motion given in the aforementioned example (rotated 90-180 degrees (±20 degrees) from the horizontal plane).

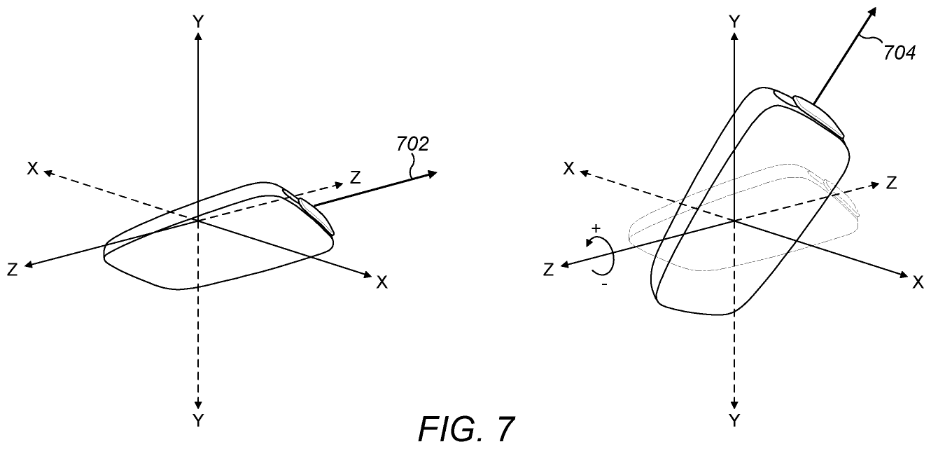

FIG. 7 is a schematic diagram of the device shown in FIG. 5, wherein the orientation of the device is depicted as changing from a third starting orientation 702 to a third finishing orientation 704.

The longitudinal axis of the device is parallel with the Z-axis in the horizontal plane in the third starting orientation 702. At step 402 in the embodiment of the invention according to FIG. 4, the sensor 104 detects that the longitudinal axis of the device rotates through 60 degrees in the positive Z-direction to reach the third finishing orientation 704. At step 404, the controller receives data from the sensor 104 and the orientation sensor 102 throughout the movement of the device between the third starting orientation 702 and the third finishing orientation 704. At step 406, the controller compares the received data of the motion of the device between the orientations 702 and 704 with data of predetermined motions stored in the data storage medium 114. The sensor 104 of the device will not be enabled to detect user inputs at step 408 as the movement of the device has not met the conditions of the predetermined motion of the aforementioned example (rotated 90-180 degrees (±20 degrees) from the horizontal plane).

In the aforementioned example of the predetermined motion (the longitudinal axis of the device has rotated 90-180 degrees (±20 degrees) from the horizontal plane (the Z or X axis)), no constraints on the translational movement of the device are given. The examples given in FIGS. 5 to 7 do not show translational movements of the device for illustrative simplicity. In other examples of the predetermined motion, constraints on the translational movement of the device may also be present. For example, the predetermined motion may be that the longitudinal axis of the device has rotated 90-180 degrees (±20 degrees) from the horizontal plane (the Z or X axis) and that the device has traversed a path that is greater than 20 cm in length but less than 1 m in length, which is indicative of a user picking up the device.

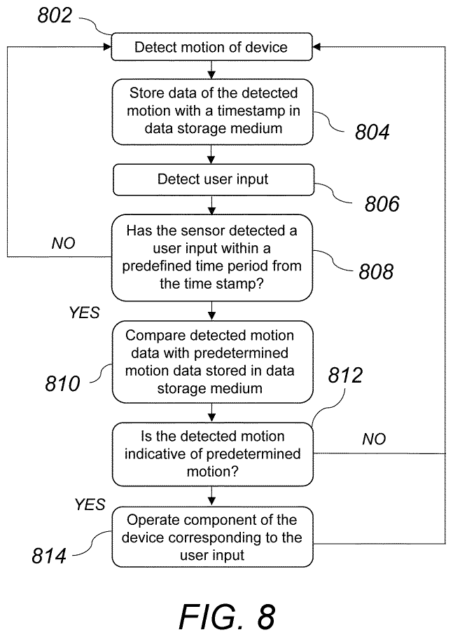

FIG. 8 is a flowchart showing a control sequence in another embodiment of the invention. At step 802, the sensor 104 detects a motion of the aerosol generating device 100. The sensor 104 is configured to provide a continuous stream of data to the controller 106 indicating time-series motion data, which may comprise accelerometer data in a Cartesian reference frame. The motion of the aerosol generating device 100 may also include changes in its orientation from the orientation sensor 102, and the orientation sensor may also be configured to provide time-series orientation data to the controller 106 including yaw, pitch and roll angular rotations. Data regarding the current motion of the aerosol generating device 100 is fed to the controller 106 from the sensor 104.

At step 804, the controller 106 receives data regarding the current motion of the aerosol generating device 100 from the sensor 104 or from the sensor 104 and the orientation sensor 102. The controller is configured to store the motion data in the data storage medium 114 along with a timestamp label of the time at which the motion data was detected. The timestamp label data may be presented in the format of hours, minutes, and seconds, for example, 12 h:34 m.56 s. The data storage medium 114 is configured to store data comprising the detected motion of the device and the associated timestamp label of when the detected motion occurred. Data stored in the data storage medium 114 is indicative of the translational and orientational movements of the device.

At step 806, the sensor detects a user input at the device. In one example, this may involve depression of the button 105. In another example, this may involve tapping or shaking the device, as detected by the sensor 104. At step 808, the controller 106 determines whether the user input was detected within a predefined time period of the time stamp associated with the detected motion data stored in the data storage medium 114. The predefined time period may be 3 seconds, for example (after the time stamp). In this example, if the timestamp label for the detected motion data is 12 h:34 m.56 s and a user input is received at 12 h:34 m.58 s, then the control sequence will progress to step 810 as the condition of step 808 has been satisfied. However, if a user input is received at 12 h:35 m.00 s, the condition of step 808 is not satisfied, and the control sequence will return to step 802.

At step 810, the controller 106 determines whether or not the detected motion data substantially matches predetermined motion data stored in the data storage medium 114 based on the comparison between the motion data received from the sensor 104 or the sensor 104 and the orientation sensor 102 and the data comprising the predetermined motion. The predetermined motion can include minimum and maximum values for expected speed of movement, range of movement and angular rotations that would be expected with the typical action of a user picking up the device 100. The predetermined motion can therefore provide a bounded range of motions, all of which would be expected for a typical pick-up action.

If the controller 106 determines that the detected motion of the aerosol generating device 100 is not indicative of predetermined motion the controller 106 prevents operation of the component of the device corresponding to the user input and the control sequence returns to step 802.

If the controller 106 determines that the detected motion of the aerosol generating device 100 is indicative of predetermined motion the controller 106 operates the component of the device corresponding to the user input, such as the heater 108. Thus, the control sequence provides for a double requirement in order for the component of the device, such as the heater, to be operated. Specifically, the control sequence requires detection of a particular predetermined motion of the device that corresponds to an expected movement of the device corresponding to the device being picked up. Subsequently, the control sequence requires detection of a user input, such as the depression of the button 105 within a predetermined time period. This provides a particular sequence of operations that correspond to expected manipulation of the device in order to initiate a vaping session. The operation, such as heating, is only initiated when this specific sequence is detected, which can improve safety by preventing unintentional activation, while reducing user frustration by permitting normal use.

1. An aerosol generating device, comprising:
an orientation sensor configured to detect the orientation of the aerosol generating device;
a sensor configured to detect tapping or shaking events at the aerosol generating device; and
a controller configured to:
enable the sensor to detect tapping or shaking in response to determining that the orientation of the aerosol generating device detected by the orientation sensor is within a predefined orientation range,
disable the sensor in response to determining that the orientation of the aerosol generating device detected by the orientation sensor is not within a predefined orientation range, and
operate a heating function of the aerosol generating device based on detection of tapping or shaking when the sensor is enabled.

2. The aerosol generating device according to claim 1, wherein the controller is configured to detect shaking that involves a movement of the aerosol generating device in the horizontal, vertical, or azimuthal directions.

3. The aerosol generating device according to claim 2, wherein the controller is further configured to operate the heating function of the aerosol generating device upon determining a direction of movement when the device is being shaken.

4. The aerosol generating device according to claim 1, wherein the orientation sensor comprises a gyroscope.

5. The aerosol generating device according to claim 1, wherein the sensor comprises an accelerometer.

6. The aerosol generating device according to claim 1, wherein the aerosol generating device comprises an outer body.

7. The aerosol generating device according to claim 6, wherein the sensor is connected to the outer body.

8. The aerosol generating device according to claim 6, wherein the sensor is configured to detect the number of times the outer body of the device has been tapped.

9. The aerosol generating device according to claim 6, wherein the sensor is configured to detect the location on the outer body that has been tapped.

10. The aerosol generating device according to claim 1, wherein the predefined orientation range comprises orientations where the longitudinal axis of the device is confined within a cone defined around a vertical axis.

11. The aerosol generating device according to claim 10, wherein the predefined orientation range is bounded by the surface of the cone that is defined around the vertical axis, and wherein the sensor is enabled sensor to detect tapping or shaking upon determining that the orientation of the aerosol generating device detected by the orientation sensor is within the bounding surface of the cone.

12. A method for using an aerosol generating device, comprising:
detecting, by an orientation sensor, an orientation of the aerosol generating device;
enabling, by a controller in response to determining that the orientation of the aerosol generating device detected by the orientation sensor is within a predefined orientation range, a sensor to detect tapping or shaking events;
disabling, by the controller, the sensor in response to determining that the orientation of the aerosol generating device detected by the orientation sensor is not within a predefined orientation range; and
operating, by the controller, a heating function of the aerosol generating device based on detection of tapping or shaking events when the sensor is enabled.

13. A computer readable memory medium comprising executable instructions, which, when executed by a computer, cause the computer to perform steps comprising the method of claim 12.

14. An aerosol generating device, comprising:
a motion sensor configured to detect the motion of the aerosol generating device;
a sensor configured to detect user inputs; and
a controller configured to:
operate a heating function of the device based on motion of the aerosol generating device being detected by the motion sensor and a user input is subsequently detected by the sensor, wherein the motion of the aerosol generating device detected by the motion sensor corresponds to a predetermined motion.
